(19) United States
(12) Patent Application Publication
(10) Pub. No.: US 2017/0190904 A1
(43) Pub. Date: Jul. 6, 2017

(54) POLYCARBONATE-POLYESTER COMPOSITION AND ARTICLE

(71) Applicant: SABIC Global Technologies B.V., Bergen op Zoom (NL)

(72) Inventors: Kumar Parimal, Mt. Vernon, IN (US); Sarah Grieshaber, Mt. Vernon, IN (US)

(21) Appl. No.: 15/308,678

(22) PCT Filed: Jul. 8, 2015
(86) PCT No.: PCT/US2015/039491

§ 371 Date: Nov. 3, 2016

Related U.S. Application Data
(60) Provisional application No. 62/034,849, filed on Aug. 8, 2014.

(51) Int. Cl. C08L 67/02; C08L 69/00

(52) U.S. Cl. CPC C08L 67/02; C08L 69/00

(57) ABSTRACT

A composition includes specific amounts of a polyester with 1,4 cyclohexanedimethylene terephthalate repeat units, a halogen-free aromatic polycarbonate, a brominated aromatic polycarbonate, and an unsubstituted or substituted C₂ C₁₈ hydrocarbyl sulfonate salt. The composition exhibits an improved balance of flame retardancy and transparency relative to a corresponding composition without the sulfonate salt. The composition can be used to fabricate articles that benefit from its transparency and flame retardancy

### BACKGROUND OF THE INVENTION

Blends of polycarbonate and polyester plastics are known. For example, a blend of a polycarbonate and a polyester that includes cyclohexanedimethylene terephthalate units exhibits good transparency and chemical resistance. However, this blend is not suitable for product applications that require high flame retardancy. The flame retardancy can be improved by partially substituting a brominated polycarbonate for the polycarbonate, but this substitution decreases the transparency of the blends. There remains a need for blends of a polycarbonate and a cyclohexanedimethylene terephthalate-containing polyester that exhibits improved flame retardancy while substantially preserving transparency.

### BRIEF SUMMARY OF EMBODIMENTS OF THE INVENTION

One embodiment is a composition comprising, based on the total weight of polymers and flame retardants: 20 to 74.95 weight percent of a polyester comprising 10 to 100 mole percent 1,4-cyclohexanedimethylene terephthalate repeat units; 20 to 50 weight percent of a halogen-free aromatic polycarbonate; 5 to 50 weight percent of a brominated aromatic polycarbonate; and 0.05 to 1 weight percent of an unsubstituted or substituted C₂-C₁₈-hydrocarbyl sulfonate salt.

Another embodiment is an article comprising the composition.

These and other embodiments are described in detail below.

### BRIEF DESCRIPTION OF THE DRAWINGS

FIG. 1 is a plot of haze for 3.2 millimeter thick color chips prepared from a composition with 48% polyester; haze is plotted as a function of brominated polycarbonate content and sulfonate salt content.

FIG. 2 is a plot of percent transmittance for 3.2 millimeter thick color chips prepared from a composition with 48% polyester; haze is plotted as a function of brominated polycarbonate content and sulfonate salt content.

FIG. 3 is a plot of haze for 3.2 millimeter thick color chips prepared from a composition with 37% polyester; haze is plotted as a function of brominated polycarbonate content and sulfonate salt content.

FIG. 4 is a plot of haze for 3.2 millimeter thick color chips prepared from a composition with 26% polyester; haze is plotted as a function of brominated polycarbonate content and sulfonate salt content.

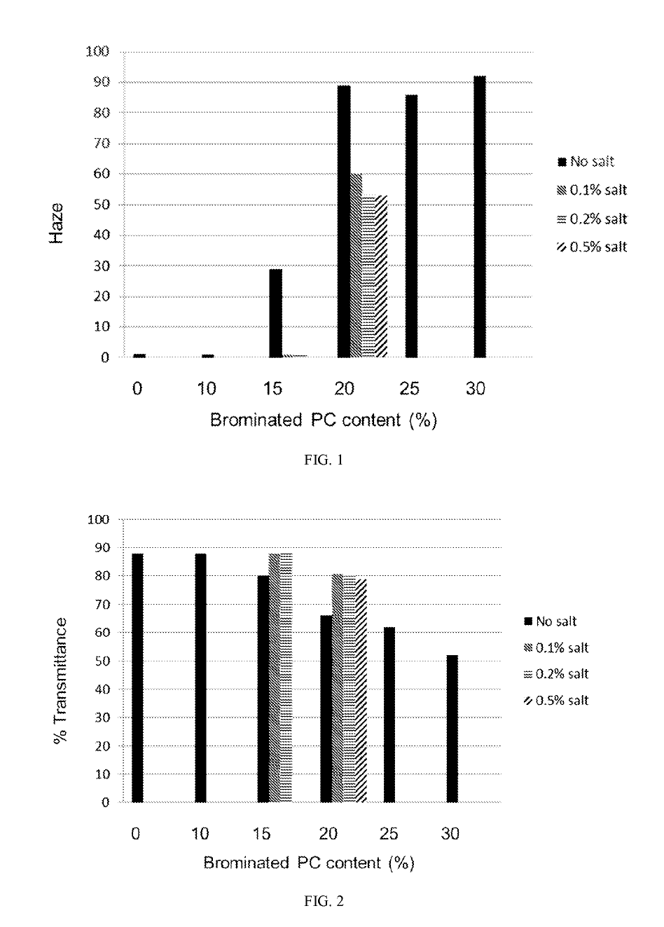

### DETAILED DESCRIPTION OF THE INVENTION

The present inventors have determined that the transparency loss that accompanies partial substitution of a brominated polycarbonate for the polycarbonate in a blend of a polycarbonate and a cyclohexanedimethylene terephthalate-containing polyester can be substantially reduced by including a small amount of an unsubstituted or substituted C₂-C₁₈-hydrocarbyl sulfonate salt in the blend.

Thus, one embodiment is a composition comprising, based on the total weight of polymers and flame retardants: 20 to 74.95 weight percent of a polyester comprising 10 to 100 mole percent 1,4-cyclohexanedimethylene terephthalate repeat units; 20 to 50 weight percent of a halogen-free aromatic polycarbonate; 5 to 50 weight percent of a brominated aromatic polycarbonate; and 0.05 to 1 weight percent of an unsubstituted or substituted C₂-C₁₈-hydrocarbyl sulfonate salt.

Component amounts are expressed in units of weight percent and calculated based on the total weight of polymers and flame retardants. Conversely, fillers, non-polymeric additives, and colorants are not included in the weight basis for weight percent calculations. It is possible that a single component can be both a polymer and a flame retardant (e.g., brominated polycarbonate). In such cases, the component amount is counted once (not twice) for its contribution to the total weight of polymers and flame retardants.

The composition comprises a polyester comprising 10 to 100 mole percent 1,4-cyclohexanedimethylene terephthalate repeat units. A 1,4-cyclohexanedimethylene terephthalate repeat unit has the chemical structure

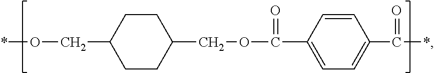

wherein the two methylene groups can be cis or trans. When the polyester comprises less than 100 percent of 1,4-cyclohexanedimethylene terephthalate repeat units, the remaining repeat units can be one or more types of C₂-C₁₈-alkylene terephthalate repeat units (other than 1,4-cyclohexanedimethylene terephthalate), one or more types of C₂-C₁₈-alkylene isophthalate repeat units, or a combination thereof. Examples of C₂-C₁₈-alkylene groups are 1,2-ethylene, 1,2-propylene, 1,3-propylene, 1,4-butylene, 1,5-pentylene, 1,6-hexylene, and 1,4-cyclohexylene. In some embodiments, the alkylene group comprises ethylene, 1,4-butylene, or a combination thereof, and the poly(alkylene terephthalate) comprises poly(ethylene terephthalate), poly(butylene terephthalate), or a combination thereof, respectively. In some embodiments, the alkylene group comprises 1,4-butylene and the poly(alkylene terephthalate) comprises poly(butylene terephthalate).

In some embodiments, the polyester comprises 10 to 95 mole percent 1,4-cyclohexanedimethylene terephthalate repeat units and 5 to 90 mole percent C₂-C₁₈-alkylene terephthalate repeat units (other than 1,4-cyclohexanedimethylene terephthalate), C₂-C₁₈-alkylene isophthalate repeat units, or a combination thereof. Within the range of 10 to 95 mole percent, the 1,4-cyclohexanedimethylene terephthalate repeat units can be 50 to 95 mole percent, specifically 70 to 90 mole percent. Within the range of 5 to 90 mole percent, the C₂-C₁₈-alkylene terephthalate repeat units (other than 1,4-cyclohexanedimethylene terephthalate), C₂-C₁₈-alkylene isophthalate repeat units, or a combination thereof can be present in an amount of 5 to 50 mole percent, specifically 10 to 30 mole percent.

In some embodiments, the polyester further comprises 1 to 90 mole percent of repeat units selected from 1,4-cyclohexanedimethylene isophthalate, ethylene terephthalate, 1,4-butylene terephthalate, and combinations thereof.

In a preferred embodiment, the polyester comprises greater than 50 to 99 mole percent 1,4-cyclohexanedimethylene terephthalate repeat units and 1 to less than 50 mole percent ethylene terephthalate repeat units. Within the range of greater than 50 to 99 mole percent, the 1,4-cyclohexanedimethylene terephthalate repeat unit amount can be 60 to 95 mole percent, specifically 70 to 90 mole percent. Within the range of 1 to less than 50 mole percent, the ethylene terephthalate repeat unit amount can be 5 to 40 mole percent, specifically 10 to 30 mole percent.

In some embodiments, the polyester has an intrinsic viscosity of 0.2 to 2 deciliter/gram, specifically 0.3 to 1.2 deciliter/gram, more specifically 0.5 to 1 deciliter/gram.

The composition comprises the polyester in an amount of 20 to 74.95 weight percent based on the total weight of polymers and flame retardants. Within this range, the polyester amount can be 25 to 70 weight percent, specifically 25 to 60 weight percent, more specifically 40 to 55 weight percent.

In addition to the polyester, the composition comprises a halogen-free aromatic polycarbonate. Aromatic polycarbonate as used herein means a polymer or copolymer having repeating structural carbonate units of the formula

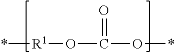

wherein at least 60 percent of the total number of R¹ groups are aromatic. Specifically, each R¹ can be derived from a dihydroxy compound such as an aromatic dihydroxy compound of the formula

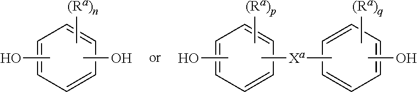

wherein n, p, and q are each independently 0, 1, 2, 3, or 4; R^{a} is independently at each occurrence halogen, or unsubstituted or substituted C₁₋₁₀ hydrocarbyl; and X^{a} is a single bond, —O—, —S—, —S(O)—, —S(O)₂—, —C(O)—, or a C₁₋₁₈ hydrocarbylene, which can be cyclic or acyclic, aromatic or non-aromatic, and can further comprise one or more heteroatoms selected from halogens, oxygen, nitrogen, sulfur, silicon, or phosphorous. As used herein, the term “hydrocarbyl”, whether used by itself, or as a prefix, suffix, or fragment of another term, refers to a residue that contains only carbon and hydrogen unless it is specifically identified as “substituted hydrocarbyl”. The hydrocarbyl residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. In the context of materials designated “halogen-free”, “substituted” means including at least one substituent such as a hydroxyl, amino, thiol, carboxyl, carboxylate, amide, nitrile, sulfide, disulfide, nitro, C₁₋₁₈ alkyl, C₁₋₁₈ alkoxyl, C₆₋₁₈ aryl, C₆₋₁₈ aryloxyl, C₇₋₁₈ alkylaryl, or C₇₋₁₈ alkylaryloxyl. When a material is not halogen-free, the term “substituted” further permits inclusion of halogens (i.e., F, Cl, Br, I).

Some illustrative examples of specific dihydroxy compounds include the following: bisphenol compounds such as 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, and 2,3,5,6-tetra-t-butyl hydroquinone.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane (DMBPC), 1,1-bis(4-hydroxy-3-methylphenyl)-3,3,5-trimethylcyclohexane (isophorone bisphenol), and combinations thereof.

In some embodiments, at least 90 percent of the total number of R¹ groups in the polycarbonate have the formula

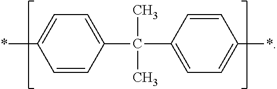

In some embodiments, the polycarbonate comprises or consists of bisphenol A polycarbonate resin.

More than one polycarbonate can be used. For example, the composition can comprise a first polycarbonate having a weight average molecular weight of 18,000 to 25,000 atomic mass units and a second polycarbonate having a weight average molecular weight of 27,000 to 35,000 atomic mass units.

Methods of forming polycarbonates are known, and many are commercially available from suppliers including SABIC Innovative Plastics, Bayer MaterialScience, and Mitsubishi Chemical Corp.

The composition comprises the halogen-free aromatic polycarbonate in an amount of 20 to 50 weight percent, based on the total weight of polymers and flame retardants. Within this range, the halogen-free aromatic polycarbonate amount can be 25 to 45 weight percent, specifically 30 to 40 weight percent.

In addition to the polyester and the halogen-free aromatic polycarbonate, the composition comprises a brominated aromatic polycarbonate. The brominated aromatic polycarbonate can be derived from a brominated dihydric phenol and a carbonate precursor. In these embodiments, a combination of two or more different brominated dihydric phenols can be used. Alternatively, the brominated aromatic polycarbonate can be derived from a carbonate precursor and a mixture of brominated and non-brominated aromatic dihydric phenols. Suitable flame retardant brominated aromatic polycarbonates are disclosed in U.S. Pat. No. 4,923,933 to Curry, U.S. Pat. No. 4,170,711 to Orlando et al., and U.S. Pat. No. 3,929,908 to Orlando et al.

In some embodiments, the brominated aromatic polycarbonate comprises repeat units having the formula

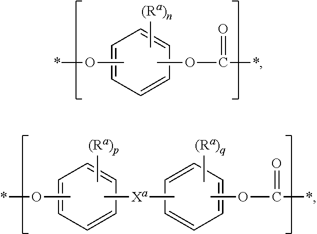

or a combination thereof; wherein n is 1, 2, 3, or 4; p and q are each independently 0, 1, 2, 3, or 4, provided that the sum of p and q is at least 1; R^{a} is independently at each occurrence halogen, or unsubstituted or substituted C₁₋₁₀ hydrocarbyl, provided that at least one occurrence of R^{a} per molecule is bromine; and X^{a} is a single bond, —O—, —S—, —S(O)—, —S(O)₂—, —C(O)—, or C₁-C₁₈ hydrocarbylene, which can be cyclic or acyclic, aromatic or non-aromatic, and can further comprise one or more heteroatoms selected from halogens, oxygen, nitrogen, sulfur, silicon, and phosphorus.

Suitable brominated dihydric phenols include 2,2-bis(3,5-dibromo-4-hydroxyphenyl)propane and 2,2′,6,6′-tetramethyl-3,3′,5,5′-tetrabromo-4,4′-biphenol. Suitable non-brominated aromatic dihydric phenols include any of those described above in the context of the halogen-free aromatic polycarbonate.

In a preferred embodiment, the brominated aromatic polycarbonate comprises repeat units having the formula

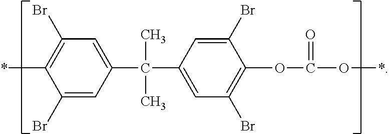

The brominated aromatic polycarbonate can be prepared according to known procedures, such as, for example, by reacting a brominated dihydric phenol, or a mixture of brominated dihydric phenol and a non-brominated dihydric phenol, with a carbonate precursor such as diphenyl carbonate or phosgene. If a mixture of dihydric phenols is used, then preferably the mixture contains at least 25 mole percent of a brominated dihydric phenol, more preferably contains at least 25 to 55 mole percent of a brominated dihydric phenol so as to yield a flame retardant brominated polycarbonate.

In some embodiments, the brominated aromatic polycarbonate has a bromine content of 10 to 50 weight percent, specifically 15 to 40 weight percent, based on the weight of the brominated aromatic polycarbonate. In some embodiments, the brominated aromatic polycarbonate contributes 2 to 20 weight percent of bromine to the composition, based on the total weight of polymers and flame retardants. Within this range, the brominated aromatic polycarbonate can contribute 2 to 15 weight percent, specifically 2 to 10 weight percent, of bromine to the composition.

In some embodiments, the brominated aromatic polycarbonate has an intrinsic viscosity of 0.2 to 1.5 deciliter per gram, measured in methylene chloride at 25° C. Within this range, the intrinsic viscosity can be 0.4 to 1 deciliter per gram. In some embodiments, the brominated aromatic polycarbonate has a weight average molecular weight of 8,000 to 200,000 atomic mass units, specifically 15,000 to 80,000 atomic mass units, as determined by gel permeation chromatography using polycarbonate standards.

The composition comprises the brominated aromatic polycarbonate in an amount of 5 to 50 weight percent, based on the total weight of polymers and flame retardants. Within this range, the brominated aromatic polycarbonate amount can be 5 to 45 weight percent, specifically 5 to 35 weight percent, more specifically 10 to 20 weight percent.

In addition to the polyester, the halogen-free aromatic polycarbonate, and the brominated aromatic polycarbonate, the composition comprises an unsubstituted or substituted C₂-C₁₈-hydrocarbyl sulfonate salt. As used herein, the term “C₂-C₁₈-hydrocarbyl sulfonate salt” refers to salt comprising an anion and a cation, wherein the anion is a sulfonate group directly bonded to an optionally substituted C₂-C₁₈ hydrocarbyl group, and the cation is an alkali metal ion (e.g., Li⁺, Na⁺, K⁺, or a combination thereof), an alkaline earth metal ion (e.g., Me⁺, Ca²⁺, or a combination thereof), an unsubstituted or substituted ammonium ion (e.g., NH₄⁺, N(CH₃)₄⁺, or a combination thereof), or a combination of two or more of the foregoing cations.

In some embodiments, the unsubstituted or substituted C₂-C₁₈-hydrocarbyl sulfonate salt comprises an alkali metal cation, an alkaline earth metal cation, or a combination thereof; and a C₂-C₁₈ perfluoroalkyl sulfonate, an unsubstituted or substituted C₆-C₂₀ aryl sulfonate, or a combination thereof.

In some embodiments, the unsubstituted or substituted C₂-C₁₈-hydrocarbyl sulfonate salt comprises potassium 3-(phenylsulfonyl)benzene sulfonate, sodium 3-(phenylsulfonyl)benzene sulfonate, potassium perfluorobutane sulfonate, sodium perfluorobutane sulfonate, sodium toluene sulfonate, potassium perfluorobutane sulfonate, potassium perfluoroctane sulfonate, tetraethylammonium perfluorohexane sulfonate, or a combination thereof.

In some embodiments, the unsubstituted or substituted C₂-C₁₈-hydrocarbyl sulfonate salt comprises potassium 3-(phenylsulfonyl)benzene sulfonate, sodium 3-(phenylsulfonyl)benzene sulfonate, potassium perfluorobutane sulfonate, sodium perfluorobutane sulfonate, or a combination thereof.

In a preferred embodiment, the unsubstituted or substituted C₂-C₁₈-hydrocarbyl sulfonate salt comprises potassium 3-(phenylsulfonyl)benzene sulfonate.

The composition comprises the unsubstituted or substituted C₂-C₁₈-hydrocarbyl sulfonate salt in an amount of 0.05 to 1 weight percent, based on the total weight of polymers and flame retardants. Within this range, the amount of the unsubstituted or substituted C₂-C₁₈-hydrocarbyl sulfonate salt can be 0.1 to 0.5 weight percent, specifically 0.1 to 0.3 weight percent.

In some embodiments, the composition comprises 1 to 10 weight percent of non-halogenated, phosphorus-containing flame retardants, based on the total weight of polymers and flame retardants. Examples of types of non-halogenated phosphorus-containing flame retardants include organophosphate esters (e.g., bisphenol A bis(diphenyl phosphate), resorcinol bis(diphenyl phosphate)), metal dialkylphosphinates (e.g., aluminum tris(diethyl phosphinate), melamine-containing flame retardants (e.g., melamine phosphate, melamine pyrophosphate, melamine polyphosphate), phosphazenes (e.g., bis(phenoxy)phosphazene oligomers and polymers), and combinations thereof. Alternatively, non-halogenated, phosphorus-containing flame retardants can be minimized or excluded. Thus, in some embodiments, the composition comprises non-halogenated, phosphorus-containing flame retardants in an amount of 0 to 2 weight percent, specifically 0 to 1 weight percent, more specifically 0 weight percent.

To avoid compromising transparency, the composition preferably minimizes or excludes fillers. As used herein, the term “fillers” includes reinforcing and non-reinforcing fillers. Fillers include silicates and silica powders such as aluminum silicate (mullite), synthetic calcium silicate, zirconium silicate, fused silica, crystalline silica graphite, natural silica sand; boron powders such as boron-nitride powder, boron-silicate powders; oxides such as TiO₂, aluminum oxide, magnesium oxide; calcium sulfate (as its anhydride, dihydrate or trihydrate); calcium carbonates such as chalk, limestone, marble, synthetic precipitated calcium carbonates; talc, including fibrous, modular, needle shaped, lamellar talc; wollastonite; surface-treated wollastonite; glass spheres such as hollow and solid glass spheres, silicate spheres, cenospheres, aluminosilicate (armospheres); kaolin, including hard kaolin, soft kaolin, calcined kaolin, kaolin comprising various coatings known in the art to facilitate compatibility with the polymeric matrix resin; single crystal fibers or “whiskers” such as silicon carbide, alumina, boron carbide, iron, nickel, copper; fibers (including continuous and chopped fibers) such as carbon fibers, glass fibers, such as E, A, C, ECR, R, S, D, or NE glasses; sulfides such as molybdenum sulfide, zinc sulfide or the like; barium compounds such as barium titanate, barium ferrite, barium sulfate, heavy spar; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or combinations comprising at least one of the foregoing fillers or reinforcing agents. In some embodiments, the composition comprises 0 to 5 weight percent of fillers, specifically 0 to 2 weight percent of fillers, more specifically 0 to 1 weight percent of fillers. In a preferred embodiment, the composition excludes fillers.

The composition can, optionally, include one or more additives. Such additives include, for example, flow modifiers, antioxidants, heat stabilizers, plasticizers, lubricants, mold release agents, antistatic agents, anti-fog agents, antimicrobial agents, radiation stabilizers, flame retardants (in addition to the brominated aromatic polycarbonate and the unsubstituted or substituted C₂-C₁₈-hydrocarbyl sulfonate salt), anti-drip agents (e.g., a styrene-acrylonitrile copolymer-encapsulated polytetrafluoroethylene (TSAN)), and combinations thereof. In general, the additives, when present, are used in a total amount of less than or equal to 5 weight percent, based on the total weight of polymers and flame retardants. Within this limit, the additives can be used in a total amount of less than or equal to 2 weight percent, specifically less than or equal to 1.5 weight percent, more specifically less than or equal to 1 weight percent. In some embodiments, the composition excludes flame retardants.

In some embodiments, the composition further comprises an impact modifier. Suitable impact modifiers include, for example, natural rubber, fluoroelastomers, ethylene-propylene rubbers (EPR), ethylene-butene rubbers, ethylene-propylene-diene monomer rubbers (EPDM), acrylate rubbers, hydrogenated nitrile rubbers (HNBR), silicone elastomers, styrene-butadiene-styrene block copolymers (SBS), styrene-butadiene rubbers (SBR), styrene-(ethylene-butene)-styrene block copolymers (SEBS), styrene-isoprene-styrene block copolymers (SIS), styrene-(ethylene-propylene)-styrene block copolymers (SEPS), acrylonitrile-butadiene-styrene copolymers (ABS, including bulk ABS and high-rubber graft ABS), acrylonitrile-ethylene-propylene-diene-styrene copolymers (AES), methyl methacrylate-butadiene-styrene block copolymers (MBS), and combinations thereof. In some embodiments in which the composition comprises impact modifier, it is present in an amount of 1 to 20 weight percent, specifically 1 to 10 weight percent, based on the total weight of polymers and flame retardants. Alternatively, impact modifier can be minimized or excluded. Thus, in some embodiments, the composition comprises 0 to 2 weight percent impact modifiers, specifically 0 to 1 weight percent impact modifiers, more specifically 0 weight percent impact modifiers.

The composition can, optionally, minimize or exclude components other than those described herein as required or optional. For examples, in some embodiments, the composition comprises 0 to 2 weight percent, specifically 0 to 1 weight percent, based on the total weight of polymers and flame retardants, of any polyester other than the polyester comprising 10 to 100 mole percent 1,4-cyclohexanedimethylene terephthalate repeat units. In some embodiments, the composition excludes any polyester other than the polyester comprising 10 to 100 mole percent 1,4-cyclohexanedimethylene terephthalate repeat units.

In some embodiments, the composition comprises 0 to 2 weight percent, specifically 0 to 1 weight percent, based on the total weight of polymers and flame retardants, of polyestercarbonates, polycarbonate-polysiloxane block copolymers, polyamides, polyimides, fluorinated polymers, and combinations thereof. In some embodiments, the composition excludes polyestercarbonates, polycarbonate-polysiloxane block copolymers, polyamides, polyimides, and fluorinated polymers.

In some embodiments, the composition comprises 0 to 2 weight percent, specifically 0 to 1 weight percent, based on the total weight of polymers and flame retardants, of any polymer other than the polyester comprising 10 to 100 mole percent 1,4-cyclohexanedimethylene terephthalate repeat units, the halogen-free aromatic polycarbonate, and the brominated aromatic polycarbonate. In some embodiments, the composition excludes any polymer other than the polyester comprising 10 to 100 mole percent 1,4-cyclohexanedimethylene terephthalate repeat units, the halogen-free aromatic polycarbonate, and the brominated aromatic polycarbonate.

In a preferred embodiment of the composition, the halogen-free aromatic polycarbonate comprises repeat units having the formula

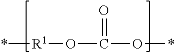

wherein at least 90 percent of the total number of R¹ groups have the formula

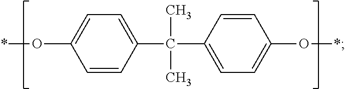

the brominated polycarbonate comprises repeat units having the formula

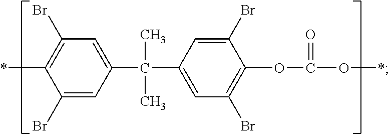

the unsubstituted or substituted C₂-C₁₈-hydrocarbyl sulfonate salt comprises potassium 3-(phenylsulfonyl)benzene sulfonate; the composition excludes fluorinated polymers, polyesters other than the polyester comprising 10 to 100 mole percent 1,4-cyclohexanedimethylene terephthalate repeat units, impact modifiers, polyestercarbonates, polycarbonate-polysiloxane block copolymers, polyamides, polyimides, flame retardants other than the brominated aromatic polycarbonate and the unsubstituted or substituted C₂-C₁₈-hydrocarbyl sulfonate salt, and fillers; and the composition comprises 40 to 55 weight percent of the polyester comprising 10 to 100 mole percent 1,4-cyclohexanedimethylene terephthalate repeat units, 30-40 weight percent of the halogen-free aromatic polycarbonate, 10 to 20 weight percent of the brominated aromatic polycarbonate, and 0.1 to 0.5 weight percent of the unsubstituted or substituted C₂-C₁₈-hydrocarbyl sulfonate salt.

Another embodiment is an article comprising the composition. All of the above-described variations of the composition apply as well to the article comprising the composition. The composition is useful to fabricate articles requiring transparency, flame retardancy, chemical resistance, and impact strength. Such articles include, for example, consumer electronics components, automotive components, mass transportation components, medical device components, electrical components, lighting components, and holders for tea lights or votive candles. Suitable methods of forming such articles include single layer and multilayer sheet extrusion, injection molding, blow molding, film extrusion, profile extrusion, pultrusion, compression molding, thermoforming, pressure forming, hydroforming, vacuum forming, and the like. Combinations of the foregoing article fabrication methods can be used.

All ranges disclosed herein are inclusive of the endpoints, and the endpoints are independently combinable with each other. Each range disclosed herein constitutes a disclosure of any point or sub-range lying within the disclosed range.

The invention includes at least the following embodiments.

### Embodiment 1

A composition comprising, based on the total weight of polymers and flame retardants: 20 to 74.95 weight percent of a polyester comprising 10 to 100 mole percent 1,4-cyclohexanedimethylene terephthalate repeat units; 20 to 50 weight percent of a halogen-free aromatic polycarbonate; 5 to 50 weight percent of a brominated aromatic polycarbonate; and 0.05 to 1 weight percent of an unsubstituted or substituted C₂-C₁₈-hydrocarbyl sulfonate salt.

### Embodiment 2

The composition of embodiment 1, wherein the polyester further comprises 1 to 90 mole percent of repeat units selected from 1,4-cyclohexanedimethylene isophthalate, ethylene terephthalate, 1,4-butylene terephthalate, and combinations thereof.

### Embodiment 3

The composition of embodiment 1 or 2, wherein the polyester comprises greater than 50 to 99 mole percent 1,4-cyclohexanedimethylene terephthalate repeat units and further comprises 1 to less than 50 mole percent ethylene terephthalate repeat units.

### Embodiment 4

The composition of any of embodiments 1-3, wherein the halogen-free aromatic polycarbonate comprises repeat units having the formula

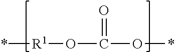

wherein at least 60 percent of the total number of R¹ groups are aromatic.

### Embodiment 5

The composition of embodiment 4, wherein at least 90 percent of the total number of R¹ groups have the formula

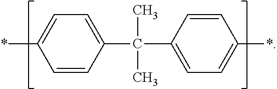

### Embodiment 6

The composition of any of embodiments 1-5, wherein the brominated polycarbonate comprises repeat units having the formula

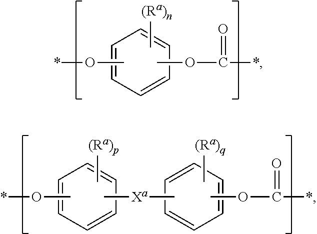

or a combination thereof; wherein n is 1, 2, 3, or 4; p and q are each independently 0, 1, 2, 3, or 4, provided that the sum of p and q is at least 1; R^{a} is independently at each occurrence halogen, or unsubstituted or substituted C₁₋₁₀ hydrocarbyl, provided that at least one occurrence of R^{a} per molecule is bromine; and X^{a} is a single bond, —O—, —S—, —S(O)—, —S(O)₂—, —C(O)—, or C₁₋₁₈ hydrocarbylene, which can be cyclic or acyclic, aromatic or non-aromatic, and can further comprise one or more heteroatoms selected from halogens, oxygen, nitrogen, sulfur, silicon, and phosphorus.

### Embodiment 7

The composition of any of embodiments 1-6, wherein the brominated polycarbonate comprises repeat units having the formula

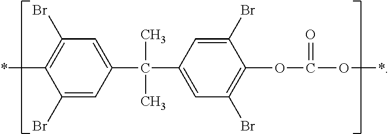

### Embodiment 8

The composition of any of embodiments 1-7, wherein the brominated polycarbonate contributes 2 to 20 weight percent bromine to the composition.

### Embodiment 9

The composition of any of embodiments 1-8, wherein the unsubstituted or substituted C₂-C₁₈-hydrocarbyl sulfonate salt comprises an alkali metal cation, an alkaline earth metal cation, or a combination thereof; and a C₂-C₁₈ perfluoroalkyl sulfonate, an unsubstituted or substituted C₆-C₂₀ aryl sulfonate, or a combination thereof.

### Embodiment 10

The composition of any of embodiments 1-9, wherein the unsubstituted or substituted C₂-C₁₈-hydrocarbyl sulfonate salt comprises potassium 3-(phenylsulfonyl)benzene sulfonate, sodium 3-(phenylsulfonyl)benzene sulfonate, potassium perfluorobutane sulfonate, sodium perfluorobutane sulfonate, sodium toluene sulfonate, potassium perfluorobutane sulfonate, potassium perfluoroctane sulfonate, tetraethylammonium perfluorohexane sulfonate, or a combination thereof.

### Embodiment 11

The composition of any of embodiments 1-10, wherein the unsubstituted or substituted C₂-C₁₈-hydrocarbyl sulfonate salt comprises potassium 3-(phenylsulfonyl)benzene sulfonate.

### Embodiment 12

The composition of any of embodiments 1-11, comprising 0 to 2 weight percent of any polyester other than the polyester comprising 10 to 100 mole percent 1,4-cyclohexanedimethylene terephthalate repeat units.

### Embodiment 13

The composition of any of embodiments 1-12, comprising 0 to 2 weight percent of impact modifiers.

### Embodiment 14

The composition of any of embodiments 1-13, comprising 0 to 2 weight percent of polyestercarbonates, polycarbonate-polysiloxane block copolymers, polyamides, polyimides, fluorinated polymers, and combinations thereof.

### Embodiment 15

The composition of any of embodiments 1-14, comprising 0 to 2 weight percent of flame retardants other than the brominated aromatic polycarbonate and the unsubstituted or substituted C₂-C₁₈-hydrocarbyl sulfonate salt.

### Embodiment 16

The composition of any of embodiments 1-15, comprising 0 to 2 weight percent of fillers.

### Embodiment 17

The composition of embodiment 1, wherein the halogen-free aromatic polycarbonate comprises repeat units having the formula

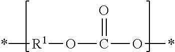

wherein at least 90 percent of the total number of R¹ groups have the formula

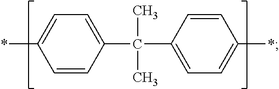

wherein the brominated polycarbonate comprises repeat units having the formula

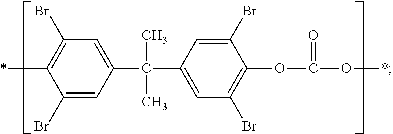

wherein the unsubstituted or substituted C₂-C₁₈-hydrocarbyl sulfonate salt comprises potassium 3-(phenylsulfonyl)benzene sulfonate; wherein the composition excludes fluorinated polymers, polyesters other than the polyester comprising 10 to 100 mole percent 1,4-cyclohexanedimethylene terephthalate repeat units, impact modifiers, polyestercarbonates, polycarbonate-polysiloxane block copolymers, polyamides, polyimides, flame retardants other than the brominated aromatic polycarbonate and the unsubstituted or substituted C₂-C₁₈-hydrocarbyl sulfonate salt, and fillers; and wherein the composition comprises 40 to 55 weight percent of the polyester comprising 10 to 100 mole percent 1,4-cyclohexanedimethylene terephthalate repeat units, 30-40 weight percent of the halogen-free aromatic polycarbonate, 10 to 20 weight percent of the brominated aromatic polycarbonate, and 0.1 to 0.5 weight percent of the unsubstituted or substituted C₂-C₁₈-hydrocarbyl sulfonate salt.

### Embodiment 18

An article comprising a composition comprising, based on the total weight of polymers and flame retardants: 20 to 74.95 weight percent of a polyester comprising 10 to 100 mole percent 1,4-cyclohexanedimethylene terephthalate repeat units; 20 to 50 weight percent of a halogen-free aromatic polycarbonate; 5 to 50 weight percent of a brominated aromatic polycarbonate; and 0.05 to 1 weight percent of an unsubstituted or substituted C₂-C₁₈-hydrocarbyl sulfonate salt.

### Embodiment 19

The article of embodiment 18, selected from consumer electronics components, automotive components, mass transportation components, medical device components, electrical components, lighting components, and holders for tea lights or votive candles.

### Embodiment 20

The article of embodiment 18 or 19, wherein the halogen-free aromatic polycarbonate comprises repeat units having the formula

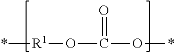

wherein at least 90 percent of the total number of R¹ groups have the formula

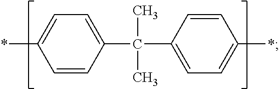

wherein the brominated polycarbonate comprises repeat units having the formula

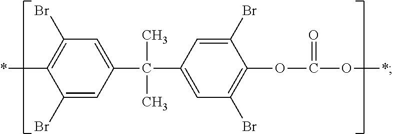

wherein the unsubstituted or substituted C₂-C₁₈-hydrocarbyl sulfonate salt comprises potassium 3-(phenylsulfonyl)benzene sulfonate; wherein the composition excludes fluorinated polymers, polyesters other than the polyester comprising 10 to 100 mole percent 1,4-cyclohexanedimethylene terephthalate repeat units, impact modifiers, polyestercarbonates, polycarbonate-polysiloxane block copolymers, polyamides, polyimides, flame retardants other than the brominated aromatic polycarbonate and the unsubstituted or substituted C₂-C₁₈-hydrocarbyl sulfonate salt, and fillers; and wherein the composition comprises 40 to 55 weight percent of the polyester comprising 10 to 100 mole percent 1,4-cyclohexanedimethylene terephthalate repeat units, 30 to 40 weight percent of the halogen-free aromatic polycarbonate, 10 to 20 weight percent of the brominated aromatic polycarbonate, and 0.1 to 0.5 weight percent of the unsubstituted or substituted C₂-C₁₈-hydrocarbyl sulfonate salt.

The invention is further illustrated by the following non-limiting examples.

### Examples 1-5, Comparative Examples 1-6

These examples illustrate the effects of polycarbonate content, brominated polycarbonate content, and sulfonate salt content.

Components used to prepare compositions are summarized in Table 1. Molecular weight values of polycarbonates were determined using gel permeation chromatography and bisphenol A polycarbonate standards.

TABLE 1

| Component | Description |
|---|---|
| PCTG | Poly(1,4-cyclohexanedimethylene terephthalate-co-ethylene |
| | terephthalate), CAS Reg. No. 25640-14-6, having a |
| | cyclohexanedimethylene content of 80 mole percent and an intrinsic |
| | viscosity of about 0.75 deciliter/gram; obtained from Eastman |
| | Chemical. |
| PC1 | p-Cumylphenol-terminated linear bisphenol A polycarbonate, CAS |
| | Reg. No. 125252-50-8, produced by interfacial polymerization and |
| | having a weight average molecular weight of about 21,900 atomic |
| | mass units as determined by gel permeation chromatography using |
| | bisphenol A polycarbonate standards; obtained in powder form from |
| | SABIC Innovative Plastics. |
| PC2 | p-Cumylphenol-terminated linear bisphenol A polycarbonate, CAS |
| | Reg. No. 125252-50-8, produced by interfacial polymerization and |
| | having a weight average molecular weight of about 21,900 atomic |
| | mass units as determined by gel permeation chromatography using |
| | bisphenol A polycarbonate standards; obtained in pellet form from |
| | SABIC Innovative Plastics. |
| PC3 | p-Cumylphenol-terminated bisphenol A polycarbonate, CAS Reg. |
| | No. 125252-50-8, having a weight average molecular weight of about |
| | 29,900 atomic mass units; obtained in pellet form from SABIC |
| | Innovative Plastics. |
| PC4 | p-Cumylphenol-terminated bisphenol A polycarbonate, CAS Reg. |
| | No. 125252-50-8, having a weight average molecular weight of about |
| | 29,900 atomic mass units; obtained in powder form from SABIC |
| | Innovative Plastics. |
| PC5 | Branched polycarbonate copolymer of bisphenol A and 1,1,1-tris(p- |
| | hydroxyphenyl)ethane, CAS Reg. No. 111211-39-3, having a weight |
| | average molecular weight of about 38,650 atomic mass units; |
| | obtained from Sabic Innovative Plastics. |
| BrPC | p-Cumylphenol-terminated polycarbonate copolymer of bisphenol A |
| | and 3,3′,5,5′-tetrabromobisphenol A, CAS Reg. No. 156042-31-8, |
| | having a bromine content of about 26 weight percent and a weight |
| | average molecular weight of about 23,600 atomic mass units; |
| | obtained from Sabic Innovative Plastics. |
| KSS | Potassium 3-(phenylsulfonyl)benzene sulfonate, CAS Reg. No. |
| | 63316-43-8; obtained as Arichem KSS-FR from Arichem LLC. |
| Water | Water, CAS Reg. No. 7732-18-5; obtained from Sabic Innovative |
| | Plastics. |
| UVA | 2-(2′-Hydroxy-5-tert-octylphenyl)benzotriazole, CAS Reg. No. |
| | 3147-75-9; obtained as CYASORB ™ UV 5411 from CYTEC. |
| GMASA | Glycidyl methacrylate-modified styrene/acryl copolymer, CAS Reg. |
| | No. 25167-42-4; having a glycidyl methacrylate content of 49 weight |
| | percent, a glass transition temperature of 54° C., a weight average |
| | molecular weight of about 6,800 atomic mass units, and an epoxy |
| | equivalent weight of about 285 grams/mole; obtained as |
| | JONCRYL ™ ADR 4368-S from BASF. |
| ECN | Epoxy cresol novolac resin, CAS Reg. No. 29690-82-2, having a |
| | softening point of 85-100° C., an epoxy equivalent weight of 217-244, |
| | and a melt viscosity of 1,400-4,000 centipoise at 150° C.; obtained as |
| | ARALDITE ™ ECN 1299 from Huntsman. |
| PETS | Pentaerythritol tetrastearate, CAS Reg. No. 115-83-3; obtained from |
| | Lonza. |
| PEPQ | Tetrakis(2,4-di-tert-butylphenyl)-1,1-biphenyl-4,4′- |
| | diylbisphosphonite, CAS Reg. No. 38613-77-3; obtained as |
| | HOSTANOX ™ P-EPQ from Clariant. |
| H₃PO₄ Soln. | Solution of 10 weight percent phosphoric acid, CAS Reg. No. |
| | 7664-38-2, in water, CAS Reg. No. 7732-18-5; obtained from Sabic |
| | Innovative Plastics. |
| TSAN | Poly(styrene-acrylonitrile)-encapsulated polytetrafluoroethylene, |
| | containing 50 weight percent polytetrafluoroethylene; obtained from |
| | SABIC Innovative Plastics. |
| Solvent Violet 36 | 1,8-bis-(p-toluidino)-9,10-anthraquinone, CAS Reg. No. 61951-89-1; |
| | obtained as MACROLEX ™ Violet 3R from Lanxess Corp. |
| Pigment Blue 60 | Indanthrone, CAS Reg. No. 81-77-6; obtained as PALIOGEN ™ Blue |
| | L 6385 from BASF. |

Unless stated otherwise, the compositions were made by the following procedures. All solid additives (e.g., stabilizers, colorants, solid flame retardants) were dry blended off-line as concentrates using one of the primary polymer powders as a carrier and starve-fed via gravimetric feeder(s) into the feed throat of the extruder. The remaining polymer(s) were starve-fed via gravimetric feeder(s) into the feed throat of the extruder as well.

Extrusion of all materials was performed on a 25 mm Werner-Pfleiderer ZAK twin-screw extruder (length to screw diameter ratio (L/D) of 33/1) with a vacuum port located near the die face. The extruder zone temperatures were 270° C. The screw speed was 300 rotations per minute, and the throughput was between 15 and 25 kilograms/hour.

After drying pellets at 80° C. for 4 hours, samples for property testing were prepared by injection molding on a 45-ton Engel injection molding machine with 22 millimeter screw or a 75-ton Engel injection molding machine with 30 millimeter screw, each operating at a barrel temperature of 270-290° C. and a mold temperature of 60° C.

Haze and color were measured on an injection molded color chip with a thickness of 3.2 millimeters. Haze, which is expressed in units of percent, was determined according to ASTM D1003-13 on a BYK Gardner Haze-Gard Plus using a 3.2 millimeter sample thickness. Transmittance, expressed in units of percent, and Yellowness Index were determined on a GretagMacbeth Color i™7 spectrophotometer

Flammability tests were conducted according to Underwriter's Laboratory Bulletin 94 “Tests for Flammability of Plastic Materials, UL 94”, 20 mm Vertical Burning Flame Test. Before testing, flame bars with a thickness of 1.0 to 3.0 millimeters were conditioned at 23° C. and 50% relative humidity for 48 or 168 hours or 70° C. for 168 hours. A set of five flame bars was tested. For each bar, a flame was applied to the bar then removed, and the time required for the bar to self-extinguish (first afterflame time, t1) was noted. The flame was then reapplied and removed, and the time required for the bar to self-extinguish (second afterflame time, t2) and the post-flame glowing time (afterglow time, t3) were noted. To achieve a rating of V-0, the afterflame times t1 and t2 for each individual specimen must have been less than or equal to 10 seconds; and the total afterflame time for all five specimens (t1 plus t2 for all five specimens) must have been less than or equal to 50 seconds; and the second afterflame time plus the afterglow time for each individual specimen (t2+t3) must have been less than or equal to 30 seconds; and no specimen can have flamed or glowed up to the holding clamp; and the cotton indicator cannot have been ignited by flaming particles or drops. To achieve a rating of V-1, the afterflame times t1 and t2 for each individual specimen must have been less than or equal to 30 seconds; and the total afterflame time for all five specimens (t1 plus t2 for all five specimens) must have been less than or equal to 250 seconds; and the second afterflame time plus the afterglow time for each individual specimen (t2+t3) must have been less than or equal to 60 seconds; and no specimen can have flamed or glowed up to the holding clamp; and the cotton indicator cannot have been ignited by flaming particles or drops. To achieve a rating of V-2, the afterflame times t1 and t2 for each individual specimen must have been less than or equal to 30 seconds; and the total afterflame time for all five specimens (t1 plus t2 for all five specimens) must have been less than or equal to 250 seconds; and the second afterflame time plus the afterglow time for each individual specimen (t2+t3) must have been less than or equal to 60 seconds; and no specimen can have flamed or glowed up to the holding clamp; but the cotton indicator can have been ignited by flaming particles or drops. Compositions not achieving a rating of V-2 were considered to have failed. In Table 2, “FOT” corresponds to t1+t2.

Compositions and properties are summarized in Table 2, where component amounts are expressed in weight percent based on total polymers and flame retardants. In these compositions, the polymers are PCTG, PC1, PC2, PC3, BrPC (which is also a flame retardant), and GMASA; KSS is a flame retardant. Conversely, the components Water, UVA, PETS, PEPQ, and H₃PO₄ Soln. are not included in the weight basis for weight percent calcluations.

The results in Table 2 show that inventive Examples 1-5, each containing a hydrocarbyl sulfonate salt, exhibit substantially reduced haze and increased transmittance relative to corresponding comparative examples without a hydrocarbyl sulfonate salt.

TABLE 2

| | | | |
|---|---|---|---|
| C. Ex. 1 | C. Ex. 2 | C. Ex. 3 | Ex. 1 |

COMPOSITIONS

| | | | | |
|---|---|---|---|---|
| PCTG | 48.62 | 48.62 | 48.62 | 48.62 |
| PC1 | 33.14 | 28.08 | 26.05 | 25.95 |
| PC2 | 10.13 | 5.06 | 5.06 | 5.06 |
| PC3 | 8.10 | 8.10 | 5.06 | 5.06 |
| BrPC | 0.00 | 10.13 | 15.19 | 15.19 |
| KSS | 0.00 | 0.00 | 0.00 | 0.10 |
| Water | 0.51 | 0.51 | 0.51 | 0.51 |
| UVA | 0.25 | 0.25 | 0.25 | 0.25 |
| GMASA | 0.25 | 0.25 | 0.25 | 0.25 |
| PETS | 0.15 | 0.15 | 0.15 | 0.15 |
| PEPQ | 0.07 | 0.07 | 0.07 | 0.07 |
| H₃PO₄ Soln. | 0.06 | 0.06 | 0.06 | 0.06 |

PROPERTIES

| Haze, 0.2 mm (%) | 1.1004 | 1.1045 | 29.9792 | 0.7464 |
|---|---|---|---|---|
| Transmittance, 0.2 mm (%) | 88.1298 | 88.1438 | 80.1214 | 88.0556 |
| FOT, 48 h conditioning (sec) | 30.0 | — | 13.6 | 20.4 |
| FOT, 168 h conditioning (sec) | 63.4 | — | 48.8 | 22.7 |
| | Ex. 2 | C. Ex. 4 | Ex. 3 | Ex. 4 |

COMPOSITIONS

| | | | | |
|---|---|---|---|---|
| PCTG | 48.62 | 48.62 | 48.62 | 48.62 |
| PC1 | 25.85 | 20.99 | 20.89 | 20.79 |
| PC2 | 5.06 | 5.06 | 5.06 | 5.06 |
| PC3 | 5.06 | 5.06 | 5.06 | 5.06 |
| BrPC | 15.19 | 20.26 | 20.26 | 20.26 |
| KSS | 0.20 | 0.00 | 0.10 | 0.20 |
| Water | 0.51 | 0.51 | 0.51 | 0.51 |
| UVA | 0.25 | 0.25 | 0.25 | 0.25 |
| GMASA | 0.25 | 0.25 | 0.25 | 0.25 |
| PETS | 0.15 | 0.15 | 0.15 | 0.15 |
| PEPQ | 0.07 | 0.07 | 0.07 | 0.07 |
| H₃PO₄ Soln. | 0.06 | 0.06 | 0.06 | 0.06 |

PROPERTIES

| | | | | |
|---|---|---|---|---|
| Haze, 0.2 mm (%) | 0.7516 | 89.3982 | 59.997 | 53.4272 |
| Transmittance, 0.2 mm (%) | 88.1582 | 66.0466 | 80.6416 | 81.439 |
| FOT, 48 h conditioning (sec) | 13.6 | — | — | 20.4 |
| FOT, 168 h conditioning (sec) | 48.8 | — | — | 22.7 |

| | | |
|---|---|---|
| Ex. 5 | C. Ex. 5 | C. Ex. 6 |

COMPOSITIONS

| | | | |
|---|---|---|---|
| PCTG | 48.62 | 48.62 | 48.62 |
| PC1 | 20.48 | 15.92 | 10.86 |
| PC2 | 5.06 | 5.06 | 5.06 |
| PC3 | 5.06 | 5.06 | 5.06 |
| BrPC | 20.26 | 25.32 | 30.39 |
| KSS | 0.51 | 0.00 | 0.00 |
| Water | 0.51 | 0.51 | 0.51 |
| UVA | 0.25 | 0.25 | 0.25 |
| GMASA | 0.25 | 0.25 | 0.25 |
| PETS | 0.15 | 0.15 | 0.15 |
| PEPQ | 0.07 | 0.07 | 0.07 |
| H₃PO₄ Soln. | 0.06 | 0.06 | 0.06 |

PROPERTIES

| | | | |
|---|---|---|---|
| Haze, 0.2 mm (%) | 52.6430 | 86.5370 | 92.4178 |
| Transmittance, 0.2 mm (%) | 78.9728 | 62.5772 | 52.3258 |
| FOT, 48 h conditioning (sec) | — | — | — |
| FOT, 168 h conditioning (sec) | — | — | — |

### Example 6

This example illustrates another inventive composition containing a hydrocarbyl sulfonate salt.

Tensile modulus and tensile strength at yield, both expressed in units of megapascals, and tensile elongation at yield and elongation at break, both expressed in units of percent, were determined according to ASTM D 638-10 at 23° C. using a Type I bar, a gage length of 50 millimeters, and a testing speed of 50 millimeters/minute. Unnotched Izod impact strength, expressed in units of joules/meter, was determined according to ASTM D 4812-11 at 23° C. using a bar with cross-sectional dimensions of 3.2 millimeters by 12.7 millimeters. Multiaxial impact total energy, expressed in units of joules, maximum load, expressed in units of kiloNewtons, and deflection at maximum load, expressed in units of millimeters, were determined according to ASTM D 3763-10 at 23° C. using a test velocity of 3.3 meters/second, and a sample thickness of 3.2 millimeters. Heat deflection temperature, expressed in units of degrees centigrade, was determined according to ASTM D 648-07 using a bar having cross-sectional dimensions of 3.2 millimeters by 12 millimeters, and a loading fiber stress of 0.455 or 1.82 megapascals. Specific gravity, which is unitless, was determined according to ASTM D 792-08, Method A.

In Table 3, component amounts are expressed in weight percent based on total polymers and flame retardants. For this example, that is equivalent to the total of PCTG, PC1, PC4, BrPC, GMASA, and KSS.

Property results, presented in Table 3, show that low haze can be achieved by a composition containing 48.62% polyester and 15.19% brominated polycarbonate.

TABLE 3

Ex. 6

COMPOSITION

| | |
|---|---|
| PCTG | 48.62 |
| PC1 | 27.88 |
| PC4 | 8.10 |
| BrPC | 15.19 |
| Water | 0.51 |
| UVA | 0.25 |
| PETS | 0.15 |
| PEPQ | 0.07 |
| GMASA | 0.25 |
| H₃PO₄ Soln. | 0.06 |
| KSS | 0.20 |

PROPERTIES

| | |
|---|---|
| Haze, 3.2 mm | 1.4 |
| Tensile Modulus (MPa) | 2110 |
| Tensile Strength at Yield (MPa) | 59 |
| Elongation at Yield (%) | 5.9 |
| Elongation at Break (%) | 126 |
| Unnotched Izod Impact (J/m) | 2130 |
| MAI total energy (J) | 66 |
| MAI max. load (kN) | 5.9 |
| MAI defl. at max. load (mm) | 19.3 |
| HDT, 0.455 MPa, 3.175 mm (° C.) | 106 |
| HDT, 1.82 MPa, 3.175 mm (° C.) | 95 |
| Specific Gravity | 1.2424 |

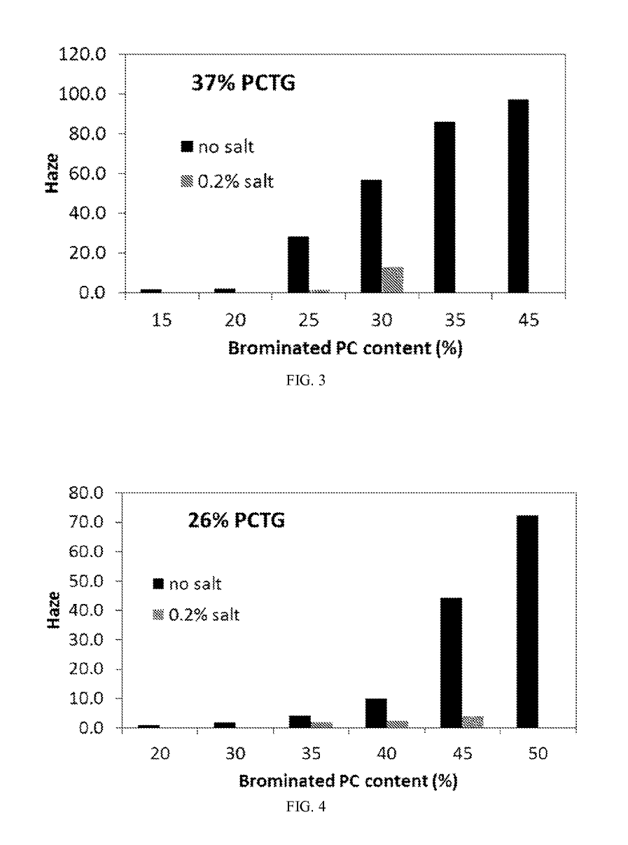

The maximum amount of brominated polycarbonate was also determined for blends with 37 and 26 weight percent polyester, based on the total weight of polymers and flame retardants. It was confirmed that the addition of the sulfonate salt substantially reduced haze and allowed a higher amount of brominated polycarbonate to be present while maintaining transparency (defined as exhibiting a haze value less than 3% at a thickness of 3.2 millimeters), which could potentially lead to better flame retardant properties for the polyester-containing blends. See FIGS. 3 and 4, and Table 4.

TABLE 4

| | |
|---|---|
| | Limit of % BrPC for |
| % PCTG | transparency |

without sulfonate salt

| | |
|---|---|
| 26 | 36-41 |
| 37 | 20-25 |
| 49 | 10-15 |

with 0.2% sulfonate salt

| | |
|---|---|
| 26 | 41-46 |
| 37 | 25-30 |
| 49 | 15-20 |

### Examples 7-11, Comparative Examples 7-9

These examples illustrate the effects of polyester content, polycarbonate content, brominated polycarbonate content, and TSAN content.

Melt volume flow rate, expressed in units of centimeter³/10 minutes, was determined according to ISO 1133-1:2011 at 265° C. and 2.16 kilogram load. Melt viscosity, expressed in units of centipoise, was determined according to ISO 11443:2005 at 265° C. and a shear rate of 195 or 1,500 seconds⁻¹. Samples were characterized as transparent if they exhibited they exhibited a haze value less than 3%.

Compositions and properties are summarized in Table 5, where component amounts are expressed in weight percent based on the total of polymers and flame retardants. For these examples, weight percent is based on the total of PCTG, PC1, PC4, PC5, BrPC, GMASA, KSS, ECN, and TSAN.

The property results in Table 5 show that the use of 0.5 weight percent TSAN is associated with a lack of transparency. The results further show that Example 10, with 26 weight percent polyester, 32.56 weight percent polycarbonate, 40 weight percent brominated polycarbonate, and 0.2 weight percent sulfonate salt, exhibits transparency and a (top) V-0 rating in the UL 94 20 mm Vertical Burning Flame Test.

TABLE 5

| | | | |
|---|---|---|---|
| Ex. 7 | Ex. 8 | Ex. 9 | Ex. 10 |

COMPOSITIONS

| | | | | |
|---|---|---|---|---|
| PCTG | 48.50 | 48.50 | 37.39 | 26.27 |
| PC1 | 27.81 | 27.85 | 29.06 | 25.93 |
| PC4 | 8.08 | 8.08 | 7.88 | 6.97 |
| PC5 | 0.00 | 0.00 | 0.00 | 0.00 |
| BrPC | 15.16 | 15.16 | 25.26 | 40.42 |
| Water | 0.51 | 0.51 | 0.51 | 0.51 |
| UVA | 0.25 | 0.25 | 0.25 | 0.25 |
| PETS | 0.15 | 0.15 | 0.15 | 0.15 |
| PEPQ | 0.07 | 0.07 | 0.07 | 0.07 |
| GMASA | 0.25 | 0.00 | 0.00 | 0.00 |
| H₃PO₄ Soln. | 0.06 | 0.06 | 0.06 | 0.06 |
| KSS | 0.20 | 0.20 | 0.20 | 0.20 |
| ECN | 0.00 | 0.21 | 0.21 | 0.21 |
| TSAN | 0.00 | 0.00 | 0.00 | 0.00 |
| Solvent Violet 36 | 0.00007 | 0.00007 | 0.00007 | 0.00007 |
| Pigment Blue | 0.00006 | 0.00006 | 0.00006 | 0.00006 |

PROPERTIES

| MVR, 265° C., 2.16 kg | 28 | 21 | 15 | 10 |
|---|---|---|---|---|
| (cm³/10 min) | | | | |
| Melt viscosity at | 565 | 680 | 892 | 664 |
| 265° C., 195 | | | | |
| sec⁻¹ (Pa-sec) | | | | |
| Melt viscosity at | 317 | 359 | 433 | 355 |
| 265° C., 1500 | | | | |
| sec⁻¹ (P-sec) | | | | |
| HDT, 1.82 MPa (° C.) | 88 | 94 | 103 | 114 |
| UL94 rating, 3 mm | V-2 | V-2 | V-2 | V-0 |
| Transparent? | yes | yes | yes | yes |
| | C. Ex. 7 | C. Ex. 8 | C. Ex. 9 | Ex. 11 |

COMPOSITIONS

| | | | | |
|---|---|---|---|---|
| PCTG | 48.50 | 37.39 | 26.27 | 37.39 |
| PC1 | 27.81 | 29.02 | 25.89 | 32.45 |
| PC4 | 7.58 | 7.38 | 6.47 | 0.00 |
| PC5 | 0.00 | 0.00 | 0.00 | 4.45 |
| BrPC | 15.16 | 25.26 | 40.42 | 25.26 |
| Water | 0.51 | 0.51 | 0.51 | 0.51 |
| UVA | 0.25 | 0.25 | 0.25 | 0.25 |
| PETS | 0.15 | 0.15 | 0.15 | 0.15 |
| PEPQ | 0.07 | 0.07 | 0.07 | 0.07 |
| GMASA | 0.25 | 0.25 | 0.25 | 0.25 |
| H₃PO₄ Soln. | 0.06 | 0.06 | 0.06 | 0.06 |
| KSS | 0.20 | 0.20 | 0.20 | 0.20 |
| ECN | 0.00 | 0.00 | 0.00 | 0.00 |
| TSAN | 0.51 | 0.51 | 0.51 | 0.00 |
| Solvent Violet 36 | 0.00007 | 0.00007 | 0.00007 | 0.00007 |
| Pigment Blue | 0.00006 | 0.00006 | 0.00006 | 0.00006 |

PROPERTIES

| | | | | |
|---|---|---|---|---|
| MVR, 265° C., 2.16 kg | 16 | 13 | 9 | 13 |
| (cm³/10 min) | | | | |
| Melt viscosity at | 414 | 508 | 694 | 897 |
| 265° C., 195 | | | | |
| sec⁻¹ (Pa-sec) | | | | |
| Melt viscosity at | 256 | 306 | 363 | 425 |
| 265° C., 1500 | | | | |
| sec⁻¹ (Pa-sec) | | | | |
| HDT, 1.82 MPa (° C.) | 99 | 105 | 117 | 107 |
| UL94 rating, 3 mm | V-2 | V-0 | V-0 | V-2 |
| Transparent? | no | no | no | yes |

1. A composition comprising, based on the total weight of polymers and flame retardants:
20 to 74.95 weight percent of a polyester comprising 10 to 100 mole percent 1,4-cyclohexanedimethylene terephthalate repeat units;
20 to 50 weight percent of a halogen-free aromatic polycarbonate;
5 to 50 weight percent of a brominated aromatic polycarbonate;
0.05 to 1 weight percent of an unsubstituted or substituted C₂-C₁₈-hydrocarbyl sulfonate salt; and
0 to 1 weight percent of polyestercarbonates, polycarbonate-polysiloxane block copolymers, polyamides, polyimides, fluorinated polymers, and combinations thereof.

2. The composition of claim 1, wherein the polyester further comprises 1 to 90 mole percent of repeat units selected from 1,4-cyclohexanedimethylene isophthalate, ethylene terephthalate, 1,4-butylene terephthalate, and combinations thereof.

3. The composition of claim 1, wherein the polyester comprises greater than 50 to 99 mole percent 1,4-cyclohexanedimethylene terephthalate repeat units and further comprises 1 to less than 50 mole percent ethylene terephthalate repeat units.

4. The composition of claim 1, wherein the halogen-free aromatic polycarbonate comprises repeat units having the formula 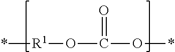
wherein at least 60 percent of the total number of R¹ groups are aromatic.

5. The composition of claim 4, wherein at least 90 percent of the total number of R¹ groups have the formula

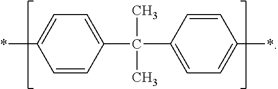

6. The composition of claim 1, wherein the brominated polycarbonate comprises repeat units having the formula 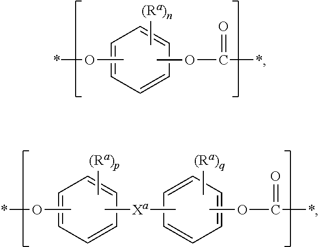
or a combination thereof; wherein n is 1, 2, 3, or 4; p and q are each independently 0, 1, 2, 3, or 4, provided that the sum of p and q is at least 1; R^{a} is independently at each occurrence halogen, or unsubstituted or substituted C₁₋₁₀ hydrocarbyl, provided that at least one occurrence of R^{a} per molecule is bromine; and X^{a} is a single bond, —O—, —S—, —S(O)—, —S(O)₂—, —C(O)—, or C₁₋₁₈ hydrocarbylene, which can be cyclic or acyclic, aromatic or non-aromatic, and can further comprise one or more heteroatoms selected from halogens, oxygen, nitrogen, sulfur, silicon, and phosphorus.

7. The composition of claim 1, wherein the brominated polycarbonate comprises repeat units having the formula

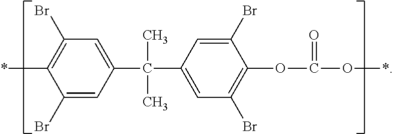

8. The composition of claim 1, wherein the brominated polycarbonate contributes 2 to 20 weight percent bromine to the composition.

9. The composition of claim 1, wherein the unsubstituted or substituted C₂-C₁₈-hydrocarbyl sulfonate salt comprises
an alkali metal cation, an alkaline earth metal cation, or a combination thereof; and
a C₂-C₁₈ perfluoroalkyl sulfonate, an unsubstituted or substituted C₆-C₂₀ aryl sulfonate, or a combination thereof.

10. The composition of claim 1, wherein the unsubstituted or substituted C₂-C₁₈-hydrocarbyl sulfonate salt comprises potassium 3-(phenylsulfonyl)benzene sulfonate, sodium 3-(phenylsulfonyl)benzene sulfonate, potassium perfluorobutane sulfonate, sodium perfluorobutane sulfonate, sodium toluene sulfonate, potassium perfluorobutane sulfonate, potassium perfluoroctane sulfonate, tetraethylammonium perfluorohexane sulfonate, or a combination thereof.

11. The composition of claim 1, wherein the unsubstituted or substituted C₂-C₁₈-hydrocarbyl sulfonate salt comprises potassium 3-(phenylsulfonyl)benzene sulfonate.

12. The composition of claim 1, comprising 0 to 2 weight percent of any polyester other than the polyester comprising 10 to 100 mole percent 1,4-cyclohexanedimethylene terephthalate repeat units.

13. The composition of claim 1, comprising 0 to 2 weight percent of impact modifiers.

14. The composition of claim 1, excluding polyestercarbonates, polycarbonate-polysiloxane block copolymers, polyamides, polyimides, and fluorinated polymers.

15. The composition of claim 1, comprising 0 to 2 weight percent of flame retardants other than the brominated aromatic polycarbonate and the unsubstituted or substituted C₂-C₁₈-hydrocarbyl sulfonate salt.

16. The composition of claim 1, comprising 0 to 2 weight percent of fillers.

17. The composition of claim 1,
wherein the halogen-free aromatic polycarbonate comprises repeat units having the formula 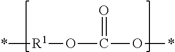
wherein at least 90 percent of the total number of R¹ groups have the formula 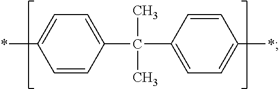
wherein the brominated polycarbonate comprises repeat units having the formula 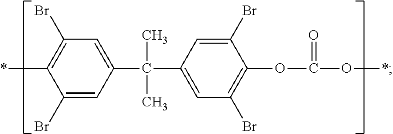
wherein the unsubstituted or substituted C₂-C₁₈-hydrocarbyl sulfonate salt comprises potassium 3-(phenylsulfonyl)benzene sulfonate;
wherein the composition excludes fluorinated polymers, polyesters other than the polyester comprising 10 to 100 mole percent 1,4-cyclohexanedimethylene terephthalate repeat units, impact modifiers, polyestercarbonates, polycarbonate-polysiloxane block copolymers, polyamides, polyimides, flame retardants other than the brominated aromatic polycarbonate and the unsubstituted or substituted C₂-C₁₈-hydrocarbyl sulfonate salt, and fillers; and
wherein the composition comprises
40 to 55 weight percent of the polyester comprising 10 to 100 mole percent 1,4-cyclohexanedimethylene terephthalate repeat units,
30 to 40 weight percent of the halogen-free aromatic polycarbonate,
10 to 20 weight percent of the brominated aromatic polycarbonate, and
0.1 to 0.5 weight percent of the unsubstituted or substituted C₂-C₁₈-hydrocarbyl sulfonate salt.

18. An article comprising a composition comprising, based on the total weight of polymers and flame retardants:
20 to 74.95 weight percent of a polyester comprising 10 to 100 mole percent 1,4-cyclohexanedimethylene terephthalate repeat units;
20 to 50 weight percent of a halogen-free aromatic polycarbonate;
5 to 50 weight percent of a brominated aromatic polycarbonate; and
0.05 to 1 weight percent of an unsubstituted or substituted C₂-C₁₈-hydrocarbyl sulfonate salt; and
0 to 1 weight percent of polyestercarbonates, polycarbonate-polysiloxane block copolymers, polyamides, polyimides, fluorinated polymers, and combinations thereof.

19. The article of claim 18, selected from consumer electronics components, automotive components, mass transportation components, medical device components, electrical components, lighting components, and holders for tea lights or votive candles.

20. The article of claim 18,
wherein the halogen-free aromatic polycarbonate comprises repeat units having the formula 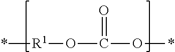
wherein at least 90 percent of the total number of R¹ groups have the formula 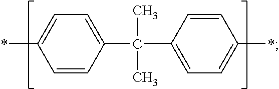
wherein the brominated polycarbonate comprises repeat units having the formula 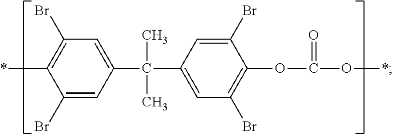
wherein the unsubstituted or substituted C₂-C₁₈-hydrocarbyl sulfonate salt comprises potassium 3-(phenylsulfonyl)benzene sulfonate;
wherein the composition excludes fluorinated polymers, polyesters other than the polyester comprising 10 to 100 mole percent 1,4-cyclohexanedimethylene terephthalate repeat units, impact modifiers, polyestercarbonates, polycarbonate-polysiloxane block copolymers, polyamides, polyimides, flame retardants other than the brominated aromatic polycarbonate and the unsubstituted or substituted C₂-C₁₈-hydrocarbyl sulfonate salt, and fillers; and
wherein the composition comprises
40 to 55 weight percent of the polyester comprising 10 to 100 mole percent 1,4-cyclohexanedimethylene terephthalate repeat units,
30 to 40 weight percent of the halogen-free aromatic polycarbonate,
10 to 20 weight percent of the brominated aromatic polycarbonate, and
0.1 to 0.5 weight percent of the unsubstituted or substituted C₂-C₁₈-hydrocarbyl sulfonate salt.
